(19) United States
(12) Patent Application Publication
(10) Pub. No.: US 2013/0000613 A1
(43) Pub. Date: Jan. 3, 2013

(54) METHOD FOR OPERATING AN INTERNAL COMBUSTION ENGINE

(75) Inventors: Cesare Maria MEANO, Torino (IT); Giovanni BASSO, Torino (IT)

(73) Assignee: GM GLOBAL TECHNOLOGY OPERATIONS LLC, Detroit, MI (US)

(21) Appl. No.: 13/534,394

(22) Filed: Jun. 27, 2012

(30) Foreign Application Priority Data
Jun. 28, 2011 (GB) 1111002.0

(51) Int. Cl. F02B 33/00

(52) U.S. Cl. 123/565

(57) ABSTRACT

A method for operating an internal combustion engine is provided. The method includes ascertaining an actual value of an operating temperature of the internal combustion engine. An electrically driven compressor located in an intake pipe of the internal combustion engine is activated if the actual value of the operating temperature of the internal combustion engine is below a threshold value thereof

### CROSS-REFERENCE TO RELATED APPLICATION

This application claims priority to British Patent Application No. 1111002.0, filed Jun. 28, 2011, which is incorporated herein by reference in its entirety.

### TECHNICAL FIELD

The technical field relates to a method for operating an internal combustion engine, principally an internal combustion engine of a motor vehicle. More particularly, the technical field relates to a method for operating an internal combustion engine soon after the startup.

### BACKGROUND

It is known that an internal combustion engine conventionally comprises an engine block including a plurality of cylinders, each of which accommodates a reciprocating piston and is closed by a cylinder head that cooperates with the piston to define a combustion chamber. The pistons are mechanically coupled to an engine crankshaft, so that a reciprocating movement of each piston, due to the combustion of the fuel in the corresponding combustion chamber, is converted into a rotation of the engine crankshaft.

A lubricating system is provided to lubricate the rotating and sliding components of the internal combustion engine. The oil system generally comprises an oil pump, which draws lubricating oil from a sump and delivers it under pressure through a main oil gallery in the engine block, whence the lubricating oil is directed towards a plurality of exit holes for lubricating crankshaft bearings (main bearings and big-end bearings), camshaft bearings operating the valves, tappets, and the like.

The internal combustion engine is further conventionally provided with an intake system for feeding fresh air into the combustion chambers, with a fuel injection system for feeding metered quantities of fuel in the combustion chambers per engine cycle, and with an exhaust system for discharging exhaust gas from the combustion chambers after the fuel combustion.

The intake system generally comprises an intake pipe leading the fresh air from the environment into an intake manifold, which comprises a plurality of branches individually connected with a respective cylinder via one or more intake ports.

The exhaust system comprises an exhaust manifold having a plurality of branches, each of which is connected with a respective cylinder via one or more exhaust ports, and an exhaust pipe leading the exhaust gas from the exhaust manifold to the environment. One or more aftertreatment devices, typically catalytic aftertreatment devices such as a Diesel Oxidation Catalyst (DOC) and others, are usually located in the exhaust pipe to reduce the pollutant emissions of the internal combustion engine.

Many internal combustion engines are also equipped with a turbocharger having the function of increasing the pressure of the air flow entering the engine cylinders, in order to enhance the engine torque. The difference between the air pressure caused by the turbocharger and the atmospheric pressure is usually referred to as the boost pressure generated by the turbocharger.

The turbocharger conventionally comprises a turbine located in the exhaust pipe, which drives a compressor located in the intake pipe. More particularly, both the turbine and the compressor comprise a respective rotating wheel provided with a plurality of vanes. The turbine wheel and the compressor wheel are mechanically connected by means of a rigid shaft, usually referred to as a turbocharger shaft, which is supported on bearings. These bearings are provided with a plurality of small holes in communication with the lubricating system of the engine, by means of which the lubricating oil is fed between the turbocharger shaft and the bearings, thereby forming a film of oil that allows the turbocharger shaft to rotate with a minimum of friction. In this way, the exhaust gas flowing in the exhaust pipe acts on the vanes of the turbine wheel, which rotates and imparts rotational movement also to the compressor wheel, which generates boost pressure.

Due to this design, the efficacy of the turbocharger is generally affected by the so called “turbo lag”, which is determined by the time required for the exhaust gas driving the turbine to come to high pressure and for the turbine wheel to overcome its rotational inertia and reach the speed necessary for the compressor wheel to effectively increase the air pressure.

During this time, a turbocharged internal combustion engine operates substantially as an aspirated engine, so that the torque generated in this condition depends mainly on the displacement of the engine cylinders. For this reason, many turbocharged internal combustion engines, in particular those having small displacement, are generally not able to promptly generate high values of torque during the first engine cycles soon after the engine startup.

This negative effect is particularly increased when the turbocharged internal combustion engine is started up under very cold conditions, because the viscosity of the lubricating oil in the engine lubricating system is so high that the pressure of the lubricating oil fed in the turbocharger is initially unable to form an effective oil film and takes some seconds before raising at a proper value. During these seconds, the friction between the turbocharger shaft and its bearings is too high for the turbine wheel and the compressor wheel to rotate properly, thereby resulting in a lack of boost pressure that causes a reduced engine torque generation.

As a consequence, if a driver actuates an engine accelerator to require high engine torque immediately after an engine startup under very cold conditions, the internal combustion engine will not be able to comply with this request and the driver will inevitably perceive an unpleasant lack of engine performance.

At least one object of an embodiment herein is that of overcoming this drawback and of enabling an internal combustion engine to generate great torque immediately after an engine startup, even under cold conditions.

Another object is that of achieving this goal with a simple, rationale and rather inexpensive solution. In addition, other objects, desirable features and characteristics will become apparent from the subsequent summary and detailed description, and the appended claims, taken in conjunction with the accompanying drawings and this background.

### SUMMARY

A method for operating an internal combustion engine is provided herein. The method includes:
ascertaining an actual value of an operating temperature of the internal combustion engine, and
activating an electrically driven compressor (e-compressor) located in an intake pipe of the internal combustion engine, if the actual value of the internal combustion engine operating temperature is below a threshold value thereof.

This embodiment provides additional boost pressure even if the internal combustion engine is started up under very cold conditions, thereby allowing more fuel to be fed and burnt in the engine cylinders and thus leading the engine to generate higher torque immediately after the startup. In fact, the e-compressor is not affected by lack of lubricating oil, because it is not connected with the engine lubrication system, and its operation depends essentially only on the state of charge of the electrical system by which it is powered.

Since a higher engine torque is generally accompanied by a higher combustion temperature inside the engine cylinders, this solution quickens the warm up of the internal combustion engine, and particularly of the engine lubricating oil, so that also a conventional turbocharger can become effective more quickly.

In addition, the higher quantity of the air and fuel mixture that burst into the engine cylinders advantageously increases the enthalpy of the exhaust gas driving the turbine of the turbocharger, so that a faster turbocharger acceleration and a reduced turbo lag are also advantageously achieved.

According to an embodiment, the internal combustion engine operating temperature is chosen among an engine coolant temperature, an engine lubricating oil temperature and an engine metal temperature.

As a matter of fact, these temperatures are correlated with one another, so that each of them can be used as a consistent index of the engine operating temperature.

In an embodiment, the actual value of the internal combustion engine operating temperature is ascertained by means of a temperature sensor.

This embodiment provides a reliable actual value of the engine operating temperature.

According to another embodiment, the operating method further includes
ascertaining an actual value of a position of an accelerator of the internal combustion engine;
   the electrically driven compressor being activated, if also the actual value of the accelerator position exceeds a threshold value thereof.

This solution activates the e-compressor only if the internal combustion engine is started under cold conditions and if actually the driver requires a great engine torque; otherwise, the e-compressor is kept inactive and the internal combustion engine is operated conventionally, thereby saving electrical energy at the engine startup.

In an embodiment, the actual value of the accelerator position is ascertained by means of an accelerator position sensor.

This embodiment provides a reliable actual value of the accelerator position.

According to still another embodiment, the method further comprises:
determining a requested value of a boost pressure for the internal combustion engine,
ascertaining an actual value of the boost pressure,
calculating an actual value of a difference between the actual value and the requested value of the boost pressure;
   the electrically driven compressor being activated, if also the calculated actual value of the difference exceeds a threshold value thereof.

This solution activates the e-compressor only if the internal combustion engine is started under cold conditions and if it is actually unable to provide enough engine torque; otherwise, the e-compressor is kept inactive and the internal combustion engine is operated conventionally, thereby saving electrical energy at the engine startup.

In an embodiment, the boost pressure requested value is determined at least on the basis of the actual value of the accelerator position.

This embodiment provides a reliable determination of the requested boost pressure.

In another embodiment, the actual value of the boost pressure is ascertained by means of a pressure sensor located in an intake manifold of the internal combustion engine.

This embodiment provides a reliable actual value of the boost pressure.

According to still another embodiment, the method comprises the further step of performing after-injections of fuel in at least a cylinder of the internal combustion engine, if the electrically driven compressor is activated.

The so called after-injections are injections of fuel performed into an engine cylinder when the piston has passed its top dead center position, so that this after-injected fuel burns inside the cylinder without sensibly increasing the engine torque. These after-injections of fuel have the function of increasing the temperature of the exhaust gas that flows into the exhaust pipe, so as to heat the aftertreatment devices located therein. Since some aftertreatment devices, including, for example, the DOC, must reach high operating temperature to become effective, this embodiment quickens the heat up of these aftertreatment devices once the engine has been started.

The methods contemplated herein can be carried out with the help of a computer program comprising a program-code for carrying out all the steps of the methods described above, and in the form of a computer program product comprising the computer program.

The computer program product can be embodied as an internal combustion engine comprising an engine control unit (ECU), a data carrier associated with the ECU, and the computer program stored in the data carrier, so that, when the ECU executes the computer program, all the steps of the embodiments of the method described above are carried out.

The method can also be embodied as an electromagnetic signal, the signal being modulated to carry a sequence of data bits which represent a computer program to carry out all steps of the method.

In another embodiment, an apparatus for operating an internal combustion engine is equipped with an electrically driven compressor located in an intake pipe, wherein the apparatus comprises:
means for ascertaining an actual value of an operating temperature of the internal combustion engine, and
means for activating the electrically driven compressor, if the actual value of the internal combustion engine operating temperature is below a threshold value thereof.

This embodiment of the apparatus, like the method disclosed above, provides additional boost pressure even when the internal combustion engine is started up under cold conditions that a conventional turbocharger cannot operate properly.

Still another embodiment provides an automotive system comprising:

an internal combustion engine including a cylinder, an intake pipe for leading air into the cylinder, a compressor located in the intake pipe and driven by an electric motor, an electric power source connected with the electric motor and an electronic control unit (ECU), wherein the ECU is configured to:
ascertain an actual value of an operating temperature of the internal combustion engine by a temperature sensor, and
supply electrical power from the electric power source to the electric motor of the compressor, so as to activate the latter, if the actual value of the internal combustion engine operating temperature is below a threshold value thereof

This embodiment, like the method disclosed above, provides additional boost pressure even when the internal combustion engine is started up under cold conditions under which a conventional turbocharger cannot operate properly.

### BRIEF DESCRIPTION OF THE DRAWINGS

The various embodiments will hereinafter be described in conjunction with the following drawing figures, wherein like numerals denote like elements, and wherein:

FIG. 1 shows an automotive system;

FIG. 2 is a section of an internal combustion engine belonging to the automotive system of FIG. 1;

FIG. 3 schematically shows an intake system and an exhaust system of the internal combustion engine of FIG. 1, according to an embodiment;

FIG. 4 schematically shows an intake system and an exhaust system of the internal combustion engine of FIG. 1, according to another embodiment; and

FIG. 5 is a flowchart of a method for operating an e-compressor of the intake system of FIG. 3 or 4, according to an embodiment.

### DETAILED DESCRIPTION

The following detailed description is merely exemplary in nature and is not intended to limit the various embodiments or the application and uses thereof Furthermore, there is no intention to be bound by any theory presented in the preceding background, summary, or the following detailed description.

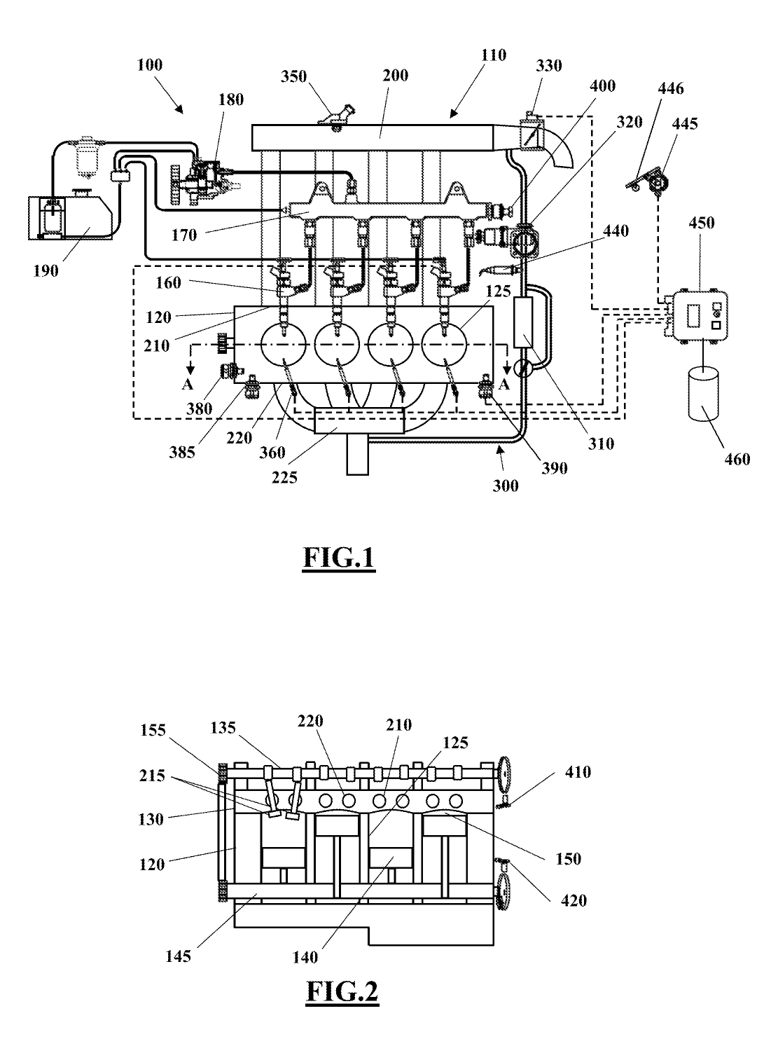

Some embodiments may include an automotive system 100, as shown in FIGS. 1 and 2, that includes an internal combustion engine (ICE) 110, in this example a Diesel engine, having an engine block 120 defining one or more cylinders 125 having a piston 140 coupled to rotate a crankshaft 145. A cylinder head 130 cooperates with the piston 140 to define a combustion chamber 150. A fuel and air mixture (not shown) ignites after having been disposed in the combustion chamber 150, resulting in hot expanding exhaust gasses causing reciprocal movement of the piston 140. The fuel is provided by a fuel injector 160 and the air through one or more intake ports 210. The fuel is provided at high pressure to the fuel injector 160 from a fuel rail 170 in fluid communication with a high pressure fuel pump 180 that increase the pressure of the fuel received from a fuel source 190. Each of the cylinders 125 has at least two valves 215, actuated by a camshaft 135 rotating in time with the crankshaft 145. The valves 215 selectively allow air into the combustion chamber 150 from the port 210 and alternately allow exhaust gases to exit through a port 220. In some examples, a cam phaser 155 may selectively vary the timing between the camshaft 135 and the crankshaft 145.

The air may be distributed to the air intake port(s) 210 through an intake manifold 200. In other embodiments, a throttle body 330 may be provided to regulate the flow of air into the manifold 200.

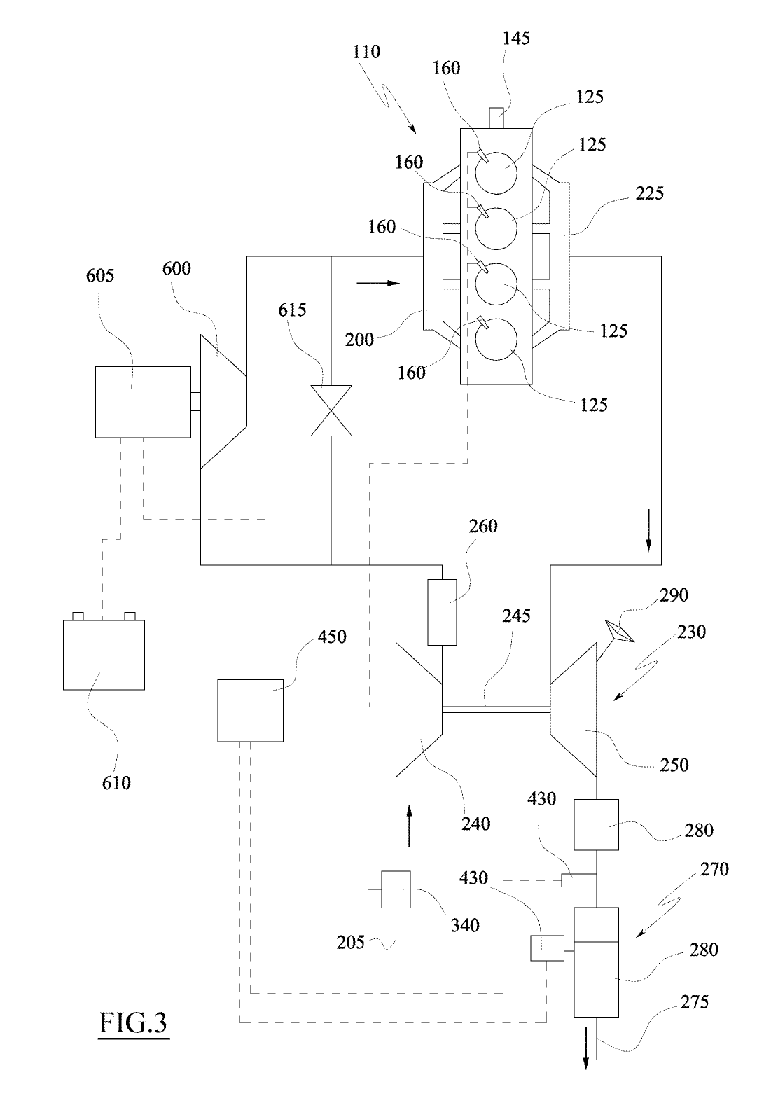

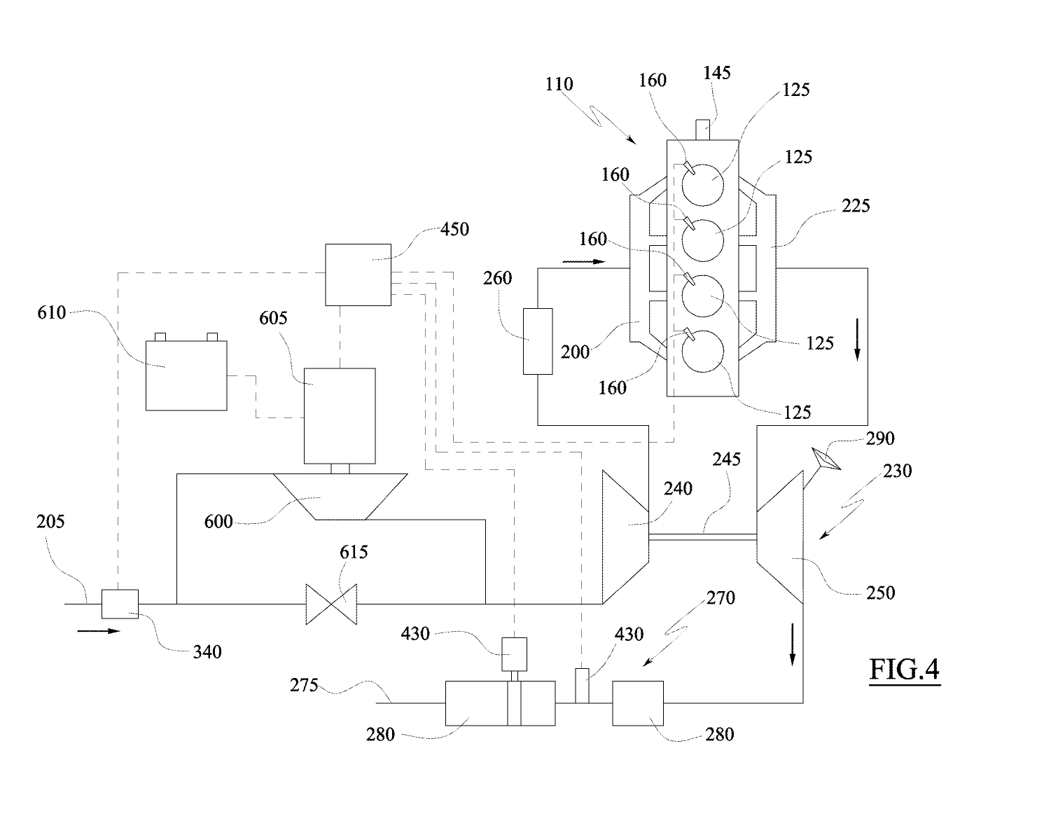

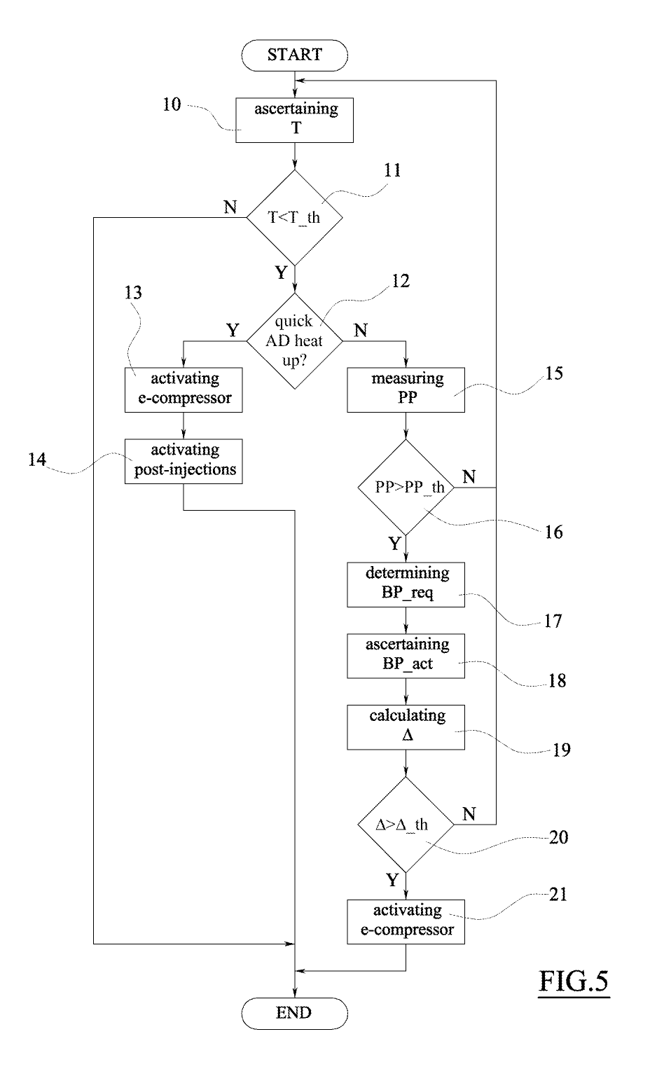

According to the scheme of FIG. 3 or 4, an air intake pipe 205 may provide air from the ambient environment to the intake manifold 200. In still other embodiments, a forced air system such as a turbocharger 230, having a compressor 240 rotationally coupled to a turbine 250 by means of a turbocharger shaft 245, may be provided. Rotation of the compressor 240 increases the pressure and temperature of the air in the intake pipe 205 and manifold 200, thereby providing a so called boost pressure. An intercooler 260 disposed in the intake pipe 205 may reduce the temperature of the air. The turbine 250 rotates by receiving exhaust gases from an exhaust manifold 225 that directs exhaust gases from the exhaust ports 220 and through a series of vanes prior to expansion through the turbine 250. The exhaust gases exit the turbine 250 and are directed into an exhaust system 270. This example shows a variable geometry turbine (VGT) with a VGT actuator 290 arranged to move the vanes to alter the flow of the exhaust gases through the turbine 250. In other embodiments, the turbocharger 230 may be fixed geometry and/or include a waste gate.

The exhaust system 270 may include an exhaust pipe 275 having one or more exhaust aftertreatment devices 280. The aftertreatment devices may be any device configured to change the composition of the exhaust gases. Some examples of aftertreatment devices 280 include, but are not limited to, catalytic converters (two and three way), oxidation catalysts, Diesel Oxidation Catalyst (DOC), lean NOx traps, hydrocarbon adsorbers, selective catalytic reduction (SCR) systems, and particulate filters. As shown in FIG. 1, other embodiments may include an exhaust gas recirculation (EGR) system 300 coupled between the exhaust manifold 225 and the intake manifold 200. The EGR system 300 may include an EGR cooler 310 to reduce the temperature of the exhaust gases in the EGR system 300. An EGR valve 320 regulates a flow of exhaust gases in the EGR system 300.

According to an embodiment, the automotive system 100 further comprises an electrically driven compressor (e-compressor) 600 located in the intake pipe 205.

A compressor is a mechanical device that generally comprises an external housing having an inlet and an outlet for a gaseous flow, and a movable component that is accommodated inside the external housing, so as to increase the pressure of that gaseous flow. The compressors can be classified into volumetric compressors or aerodynamic compressors.

A volumetric compressor is a compressor whose movable component is arranged in the external casing so as to delimit one or more operating chambers, and to alternatively open these chambers to the inlet and to the outlet, so as to cause a cyclical transfer of a certain quantity of gas from the inlet to the outlet, while preventing the gas to flow back. In some embodiments, whilst the chamber is closed for both the inlet and the outlet, the motion of the movable component causes the internal volume of the operating chamber to decrease, so as to further compress the gas contained therein. Typical volumetric compressors are for example the alternative compressors (comprising a piston that reciprocates in a cylinder), the rotary screw compressors, the rotary vane compressors, Roots compressors, Lysholm compressors, G-Lader scroll-type compressors, etc.

An aerodynamic compressor is a compressor whose movable component is a rotor or impeller equipped with vanes that add kinetic-energy/velocity to the gaseous stream flowing through the external casing. This kinetic energy is then converted to an increase of static pressure by slowing the flow through a diffuser, which is generally located at the outlet of the external casing. Typical volumetric compressors are for example the centrifugal compressors.

The e-compressor 600 according to an embodiment can be a conventional compressor, either of volumetric or aerodynamic type, which further comprises an electric motor 605 for driving its movable component.

The electric motor 605 of the e-compressor 600 can be powered by an electric power source 610 of the automotive system 100, typically a battery, via a suitable electric circuit. Possibly, the electric circuit can comprise super-capacitors that are charged by the electric power source 610, so as to power the electric motor 605 of the e-compressor 600 with higher starting currents.

With reference to the direction of the inducted air, the e-compressor 600 can be located either downstream (as shown in FIG. 3) or alternatively upstream of the turbocharger compressor 240 (as shown in FIG. 4), with reference to the direction of the air stream entering the ICE 110.

As a matter of fact, the e-compressor 600 located upstream of the turbocharger compressor 240 has the advantage of compressing air that is fresher than that compressed by the e-compressor 600 located downstream, thereby improving the combustion processes within the engine cylinders 125. Conversely, the e-compressor 600 located downstream of the turbocharger compressor 240 has the advantage of compressing air that is directly fed into the intake manifold 200, without any relevant pressure loss.

In both cases, the e-compressor 600 is connected in parallel with a bypass valve 615, which opens when the turbocharger 230 reaches an appropriate rotational speed, thereby allowing the incoming air to bypass the e-compressor 600.

The automotive system 100 may further include a conventional oil system (not shown) suitable for lubricating the rotating or sliding components of the ICE 110. The oil system generally comprises an oil pump driven by the engine, which draws lubricating oil from a sump and delivers it under pressure through a main oil gallery realized in the engine block 120. The main oil gallery is connected via respective pipes to a plurality of exit holes for lubricating crankshaft bearings (main bearings and big-end bearings), camshaft bearings operating the valves, tappets, and the like. The main oil gallery is further connected with the turbocharger 230, in order to lubricate the movable components thereof, in particular the turbocharger shaft 245 and its bearings.

The automotive system 100 may further include a conventional cooling system (not shown) for cooling some fixed parts of the ICE 110, such as for example the engine block 120 and the cylinder head 130. The cooling system generally comprises a plurality of channels running through the engine block 120 and the cylinder head 130, a radiator in communication with the channels, and a pump for circulating the engine coolant in the system.

The automotive system 100 may further include an electronic control unit (ECU) 450 in communication with one or more sensors and/or devices associated with the ICE 110. The ECU 450 may receive input signals from various sensors configured to generate the signals in proportion to various physical parameters associated with the ICE 110. The sensors include, but are not limited to, a mass airflow and temperature sensor 340 located in the intake pipe 205, an intake manifold pressure and temperature sensor 350, a combustion pressure sensor 360, a coolant temperature sensor 380, a coolant level sensors (not shown), a lubricating oil temperature sensor 385, a lubricating oil level sensor (not shown), a fuel rail pressure sensor 400, a cam position sensor 410, a crank position sensor 420, exhaust pressure and temperature sensors 430, an engine metal temperature sensor 390, an EGR temperature sensor 440, and a wide range position sensor 445 of an accelerator pedal 446. Furthermore, the ECU 450 may generate output signals to various control devices that are arranged to control the operation of the ICE 110, including, but not limited to, the fuel injectors 160, the throttle body 330, the EGR Valve 320, the VGT actuator 290, and the cam phaser 155. Note, dashed lines are used to indicate communication between the ECU 450 and the various sensors and devices, but some are omitted for clarity.

Turning now to the ECU 450, this apparatus may include a digital central processing unit (CPU) in communication with a memory system 460 and an interface bus. The memory system 460 may include various storage types including optical storage, magnetic storage, solid state storage, and other non-volatile memory. The interface bus may be configured to send, receive, and modulate analog and/or digital signals to/from the various sensors and control devices.

The CPU is configured to execute instructions stored as a program in the memory system 460, and send and receive signals to/from the interface bus. The program may embody the methods disclosed herein, allowing the CPU to carryout out the steps of such methods and control the ICE 110.

In particular, the ECU 450 is configured to determine the requested quantity of fuel to be injected during each engine cycle and to operate the fuel injectors 160 accordingly.

In order to accomplish this task, the ECU 450 generally determines a requested value of engine torque to be generated in the current engine cycle. This determination is usually made on the basis of the current position of the accelerator pedal 446, as provided by the position sensor 445, which is used as input of a calibrated map that returns as output a correspondent engine torque requested value. As a matter of fact, the engine torque requested value is directly proportional to the position of the accelerator pedal 446: the greater is the accelerator position value (namely the pedal displacement caused by the pressure exerted by the driver), the greater is the requested value of the engine torque. The determined engine torque requested value is then applied to another calibrated map that returns a requested value of a quantity of fuel to be injected during the engine cycle. This fuel quantity requested value corresponds to the fuel quantity that is expected to achieve the requested value of engine torque, if the ICE 110 operates in ideal conditions. The fuel quantity requested value can possibly be corrected by the ECU 450 according to specific control strategies of other engine components and/or functions.

The ECU 450 is further configured for controlling the operation of the e-compressor 600. In this regard, as soon as the ICE 110 is started up, the ECU 450 is configured for carrying out an e-compressor operating strategy, an embodiment of which is represented is the flow chart of FIG. 5.

According to this embodiment, the ECU 450 firstly ascertains an actual value T of an operating temperature of the ICE 110 (block 10). The operating temperature can be the temperature of the engine coolant, the temperature of the engine lubricating oil, or the temperature of the engine metal. The engine coolant temperature can be measured by means of the temperature sensor 380. The lubricating oil temperature can be measured by means of the temperature sensor 385. The engine metal temperature, that is the temperature of a metal casting component of the ICE 110 such as for example the engine block 120 or the cylinder head 130, can be measured by means of the temperature sensor 390. The actual value T of the engine operating temperature can be also estimated on the basis of other parameters related to such a temperature, for example parameters of the fuel combustion processes, inducted air temperature, time elapsed from the start of the ICE 110, and many other.

The actual value T of the engine operating temperature is then compared with a threshold value T_th thereof (block 11). The threshold value T_th of the engine operating temperature is empirically determined during a calibration activity and it is stored in the memory system 460. In particular, the threshold value T_th is determined as the value of the engine operating temperature below which the lubricating oil is too viscous to effectively lubricate the turbocharger 230. By way of example, considering the lubricating oil temperature as the engine operating temperature, the threshold value T_th is generally less than 0° C., and typically less than −25° C., for example about −40° C.

If the comparison returns that the actual value T is not below the threshold value T_th, then the operating strategy is ended without activating the e-compressor 600 and operating the ICE 110 conventionally.

If conversely the comparison returns that the actual value T is below the threshold value T_th, then the operating strategy provides for the ECU 450 to decide whether a quick heating up of one or more aftertreatment devices 280 is needed (block 12). The decision is made by the ECU 450 according to a dedicated strategy for controlling the operation of the aftertreatment devices 280, which is not within the scope of the present description.

If the decision is positive, the method provides for the ECU 450 to activate the e-compressor 600 (block 13), and to contemporaneously command (block 14) the fuel injectors 160 so as to perform one or more after-injections per engine cycle, as long as the e-compressor 600 is kept active. The after-injections are injections of fuel performed into an engine cylinder 125 when the piston 140 has passed its top dead center position, so that this after-injected fuel burns inside the cylinder 125 without sensibly increasing the engine torque. These after-injections of fuel increase the temperature of the exhaust gas that flows into the exhaust pipe 275, thereby quickening the heat-up of the aftertreatment devices 280 located therein. During the activation period, the ECU 450 can control the e-compressor 600 to operate at a constant speed, namely a constant value of the rotational or linear speed of its movable component, so as to generate a constant value (typically small) of the boost pressure. The e-compressor 600 and the after-injections of fuel can be kept active for a predetermined time period or, alternatively, until the aftertreatment device 280 to be heated reaches a predetermined value of temperature, which can be monitored for example by means of a dedicated temperature sensor or by means of the exhaust gas temperature sensors 430.

It should be understood that, in this case, the e-compressor 600 and the after-injections of fuel are activated even if the driver is not requesting a high value of engine torque, for example even if the accelerator pedal 446 is completely released and the ICE 110 is in idle condition.

If conversely the block 12 returns a negative decision, the operating strategy provides for the ECU 450 to ascertain an actual value PP of the position of the accelerator pedal 446 (block 15). The actual value PP of the accelerator pedal position can be measured by means of the accelerator pedal position sensor 445.

The actual value PP of the engine operating temperature is then compared with a threshold value PP_th thereof (block 16). The threshold value PP_th of the engine operating temperature is empirically determined during a calibration activity and it is stored in the memory system 460. In particular, the threshold value PP_th is determined as the value of the accelerator pedal position for which the driver is asking a high value of the engine torque.

If the comparison returns that the actual value PP is below the threshold value PP_th, namely if the requested torque is not at a high value, then the operating strategy provides for going back to the first block 10, while keeping the e-compressor 600 inactive and operating the ICE 110 conventionally.

If conversely the comparison returns that the actual value PP is above the threshold value P_th, namely if the requested torque is at a high value, then the operating strategy provides for the ECU 450 to determine (block 17) a requested value BP_req of the boost pressure to be generated in the intake manifold 200.

The requested value BP_req can be determined by the ECU 450 on the basis of many engine parameters, among which the actual value PP of the accelerator pedal position. By way of example, the actual value PP of the accelerator pedal position can be used as one of the inputs of a map that provides as output a corresponding value BP_req of the boost pressure. This map can be empirically determined during a calibration activity and stored in the memory system 460. In particular, the map can be determined so as to provide a boost pressure requested value BP_req that is theoretically needed for the ICE 110 to generate a torque value as requested by the actual position PP of the accelerator pedal 446.

At this point, the method provides for the ECU 450 to ascertain an actual value BP_act of the boost pressure generated in the intake manifold 200 (block 18). The actual value BP_act of the boost pressure can be measured by means of the intake manifold pressure sensor 350.

The requested value BP_req and the actual value BP_act of the boost pressure are then used to calculate an actual value Δ of the difference between them (block 19):

Δ=BP_req−BP_act

The actual value Δ of the difference is then compared with a threshold value Δ_th thereof (block 20). The threshold value Δ_th of the difference can be empirically determined during a calibration activity and stored in the memory system 460. In particular, the threshold value Δ_th can be determined as the value of the boost pressure difference for which the driver would perceive an excessive lack of performance from the ICE 110, compared to what he actually requires through the accelerator pedal 446. By way of example, the threshold value Δ_th can be comprised in a range between 0.5 and 1 bar.

If the comparison returns that the actual value Δ is below the threshold value Δ_th, then the operating strategy provides for going back to the first block 10, while keeping the e-compressor 600 inactive and operating the ICE 110 conventionally.

If conversely the comparison returns that the actual value Δ is above the threshold value Δ_th, then the operating strategy provides for the ECU 450 to activate the e-compressor 600 (block 21) during the operation of the ICE 110.

The e-compressor 600 can be kept active for a predetermined time period or, alternatively, until the monitored T value of the engine operating temperature rises above the threshold value T_th. During the activation period, the ECU 450 can control the e-compressor 600 to operate at a variable speed, namely a variable value of the rotational or linear speed of its movable component, so as to regulate the value of the boost pressure generated by the e-compressor 600 to compensate for the actual value Δ of the boost pressure difference.

Also in this case, as long as the e-compressor 600 is kept active, the ECU 450 can possibly command the fuel injectors 160 to perform one or more after-injections of fuel per engine cycle, in order to quicken the heat-up of the aftertreatment devices 280 located in the exhaust pipe 275.

It should be understood that any activation of the e-compressor 600 mentioned in the preceding description is attained by the ECU 450 that allows the electric power source 610 to supply electrical power to the electric motor 605 of the e-compressor 600, so as to move the movable component thereof.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents.

What is claimed is:

1. A method for operating an internal combustion engine, the method comprising the steps of:
ascertaining an actual value of an operating temperature of the internal combustion engine, and
activating an electrically driven compressor located in an intake pipe of the internal combustion engine, if the actual value of the operating temperature of the internal combustion engine is below a threshold value thereof.

2. The method according to claim 1, wherein the operating temperature of the internal combustion engine is chosen from an engine coolant temperature, an engine lubricating oil temperature, and an engine metal temperature.

3. The method according to claim 1, wherein the operating temperature of the internal combustion engine is ascertained by a temperature sensor.

4. The method according to claim 1, comprising a further step of ascertaining an actual value of a position of an accelerator of the internal combustion engine, wherein the electrically driven compressor is activated if the actual value of the position of the accelerator exceeds a threshold value thereof.

5. The method according to claim 4, wherein the actual value of the position of the accelerator is ascertained by an accelerator position sensor.

6. The method according to claim 1, comprising further steps of:
determining a requested value of a boost pressure for the internal combustion engine;
ascertaining an actual value of the boost pressure;
calculating a calculated actual value of a difference between the actual value and the requested value of the boost pressure;
the electrically driven compressor being activated if the calculated actual value of the difference exceeds a threshold value thereof.

7. The method according to claim 6, wherein the requested value of the boost pressure is determined on a basis of an actual value of an accelerator position.

8. The method according to claim 6, wherein the actual value of the boost pressure is ascertained by a pressure sensor located in an intake manifold of the internal combustion engine.

9. The method according to claim 1, comprising a further step of performing after-injections of fuel in a cylinder of the internal combustion engine if the electrically driven compressor is activated.

10. A computer program product comprising a non-transitory computer usable medium having a computer readable program embodied therein, the computer readable program adapted to be executed to implement a method for operating an internal combustion engine, the method comprising the steps of:
ascertaining an actual value of an operating temperature of the internal combustion engine; and
activating an electrically driven compressor located in an intake pipe of the internal combustion engine, if the actual value of the operating temperature of the internal combustion engine is below a threshold value thereof.

11. The computer program product according to claim 10, wherein the computer program product is the internal combustion engine and the non-transitory computer usable medium is an engine control unit.

12. An apparatus for operating an internal combustion engine equipped with an electrically driven compressor located in an intake pipe, wherein the apparatus comprises:
means for ascertaining an actual value of an operating temperature of the internal combustion engine, and
means for activating the electrically driven compressor, if the actual value of the operating temperature of the internal combustion engine is below a threshold value thereof.

13. An automotive system comprising:
an internal combustion engine including a cylinder, an intake pipe for leading air into the cylinder, a compressor located in the intake pipe and driven by an electric motor, an electric power source connected with the electric motor and an electronic control unit (ECU), wherein the ECU is configured to:
ascertain an actual value of an operating temperature of the internal combustion engine by a temperature sensor; and
supply electrical power from the electric power source to the electric motor of the compressor, so as to activate the latter if the actual value of the operating temperature of the internal combustion engine is below a threshold value thereof.
